(19) United States
(12) Patent Application Publication
(10) Pub. No.: US 2007/0055570 A1
(43) Pub. Date: Mar. 8, 2007

(54) Method for improvement of promotion response

(76) Inventor: David Martin, Stamford, CT (US)

Correspondence Address: ST. ONGE STEWARD JOHNSTON & REENS, LLC, 986 BEDFORD STREET, STAMFORD, CT, 06905-5619, US

(21) Appl. No.: 11/598,277

(22) Filed: Nov. 13, 2006

Related U.S. Application Data
(63) Continuation of application No. 09/705,671, filed on Nov. 3, 2000, now abandoned.

(51) Int. Cl. G06Q 30/00

(52) U.S. Cl. 705/14

(57) ABSTRACT

A method of and software for determining effectiveness of sales call efforts in a marketing environment in which representatives make contact with a customer in accordance with a prioritized list, comprising the steps of: (1) creating on a computer an electronic prioritized list of customers for representatives of an organization to use in contacting customers, the prioritized list including an identification of a customer identity and a specified contact frequency for each such customer to be executed by the representatives; (2) adjusting the specified contact frequency for a selected subset of customers on said electronic prioritized list to create an electronic adjusted prioritized list; (3) communicating the electronic adjusted prioritized list to the representatives (e.g. by generating call lists for each representative or groups of representatives); and (4) measuring changes in the promotional response among the selected subset of customers and recording data relating to said changes in an electronic data storage system. The invention further includes a method of improving effectiveness of such sales call efforts by a further step of using the measured change in promotional response among the selected subset of customers as an input to creation of an updated prioritized list with a modified contact frequency targeting the customers most likely to yield additional sales.

### CROSS-REFERENCE TO RELATED APPLICATIONS

This application is a continuation of U.S. patent application Ser. No. 09/705,671 filed Nov. 3, 2000.

### FIELD OF THE INVENTION

The present invention relates generally to the response measurement of personal direct sales or service and the use of such results to change customer prioritization or change the allocation of sales or service effort to current or potential customers.

### BACKGROUND OF THE INVENTION

Many organizations use direct personal promotion in order to maintain or increase sales with existing customers, or obtain sales or sales leads from new customers. The subsequent use of the term “direct personal promotion” shall generally refer to any situation where a person(s) makes contact(s) with a specific customer with the objective of directly, or indirectly, increasing or maintaining sales from that customer. The contact may be a sales or service call, but also can be measured in terms of supplies, information, offers, and/or promotional material that may be provided to the customer. The subsequent use of the term “representative” shall generally refer to any individual that conducts either a selling or service role to specific customers. The subsequent use of the term “customer” shall generally refer to any entity, either an individual or an organization, that is a current or potential customer, or sales prospect. The subsequent use of the term “contact” shall generally refer to any means that a representative communicates with or provides service to a customer, including, but not limited to, a personal visit, a personal phone call, a letter or brochure, an e-mail, etc. The subsequent use of the term “organization” shall generally refer to any entity, either an individual or an organization, that uses representatives to make direct personal promotion.

In many situations the representative is provided a list of customers to contact. The list generally will have customers prioritized, or will provide information to help the representative to prioritize the customers, so that the representative is given direction, or a specific recommendation, about which customers should receive greater, or sooner, attention or effort. In some cases the representative may also be given very specific guidance to the amount of effort to be given. For example, a pharmaceutical representative might be given a prioritized list each month that contains names of specific doctors for the representative to contact, the frequency that contact should be made, and the drug(s) that should be the effort of the contacts. There could also be information regarding the amount of supplies, drug samples, selling material, educational service, etc. that should be provided to each doctor. The term “prioritized list” as used herein shall broadly refer to a communication by which an organization provides representatives with guidance on specific customers to contact and/or provide sales or service promotion, and encompasses both the overall master list and portions thereof provided to specific representatives regarding the specific customers they work with. A “prioritized list” as used herein specifically shall include a call list provided to a pharmaceutical representative that specifies doctors for that representative to contact, and the number of calls to make. Such a prioritized list may be in the form of a call list, e.g. a list of names with a call frequency for a specific time period, and the particular drugs(s) that should be the focus of the calls, or it may be in the form of a calendar that provides a specific contact schedule.

The use of prioritized list provides many advantages to the organization and to the sales representative. Usually the organization can more efficiently obtain and process information that helps identify sales opportunities than an individual representative can obtain and process the information. For instance, a pharmaceutical company can purchase information about the prescription activity of each physician in the United States, assign each physician to a specific sales representative, and provide a report to each representative showing all physicians in the representative's territory and the amount of prescription activity of each physician. If each individual representative were to develop their own list, it would be significantly more costly, require significant amount of representatives' time, and result in lists of varying, and probably, lower quality.

Organizations can also analyze data in lists more effectively and efficiently than individual representatives resulting in improvements in prioritization. For instance, an organization might determine that a specific set, or segment, of customers generally buy 15% more than average customers. This segment of customers could be given higher priority in the prioritized list. Because of the huge variability of sales results, many individual sales representatives would often not detect this 15% advantage in this customer segment and therefore not give these customers greater priority.

Organizations can also use prioritized lists to provide direction to representatives for reasons or information that is not available to the representative, or to anticipate events that may not be know to most representatives. For instance, the organization may anticipate introducing a new product or service in the near future, but has not yet announced this new product or service. The organization may give greater prioritization to customers anticipated to buy this product in the future with the goal of having representatives develop greater understanding and/or relationships with the customers so as to accelerate sales of the product or service once it is introduced.

In reality, representatives will not make contact with or provide sales promotion to customers exactly as indicated, or with the exact priority, implied or recommended, in the prioritized list. This may be for many different reasons including that the prioritized list has errors about customers, the prioritization is not accurate, specific customers are not available to be contacted, specific customers do not want to be contacted, the sales representative does not use the prioritized list or modifies the prioritization, the representatives uses judgment or past experience to determine that some customers should have a different priority, the representative determines that customers should have a different priority based on information or impressions gained from initial contacts, etc.

In general, the degree that a representative deviates from the prioritized list will depend on the accuracy of the prioritization, the ability of the representative to recognize differences between the relative opportunity provided or implied by the prioritized list and the actual relative customer opportunity, and the degree to which the representative is directed or required to follow the prioritized list. It should be recognized that regardless of the specificity of guidance provided by a prioritized list, prioritized lists are rarely exactly accurate. This is not only because there may be errors in information used to compile the list, but also errors in how the information is used to establish priorities, and, most importantly, a limited amount of information that can be obtained and included in such lists.

For example, a prioritized list could often include information about a customer's size (larger being generally, but not always, better), but would often not have information about contracts and contract expiration dates that the customer might have with an organization's competitors. Such information would greatly impact the overall priority of the customer. A representative, either from past contact with a customer or from a new initial contact, might know that a specific customer had a long-term contract with a competitor and no intention of making any changes for a considerable time. The representative could usually be anticipated to give such customer less near-term attention, effort, or priority than suggested by a prioritized list. Conversely, should the representative determine a customer was dissatisfied with a competitor's product or service, and anxious to try an alternative, it could usually be anticipated that the representative would give greater priority to this customer than suggested by a prioritized list that did not incorporate this information.

Organizations will generally want to know if the sales or service efforts are generating a response. The subsequent use of the term “promotion response” shall generally refer to any increase in sales, prevention of the erosion of sales, or generating other measurable results that are advantageous to the organization that is the causal result of sales or service effort by representatives. This response could be measured in terms of dollars or units of products or services sold, profit generated, or other measures such as customer satisfaction or purchase continuity. It should be noted that unchanged sales represents a promotion response if sales would have otherwise changed if not for sales promotion. Also, a change in sales does not represent a promotion response if this change is not the causal result of sales promotion.

Generally an organization would desire and expect to have a positive promotion response in response to sales efforts. Knowing the degree of the promotion response as correlated to sales efforts is critical to determining how much direct personal promotion should be used, and whether it provides an attractive financial return.

To this end, the organization will keep track of the prioritized list provided to representatives, the number of contacts, amount of sales or service effort, and/or amount of supplies or other promotional material or offers provided to each customer, and the sales or other objective results of each customer. It is usually assumed that such information can be used to determine the promotion response.

However, because of the nature of the selling or service systems described, methods used to determine promotion response will usually give erroneous results. Such erroneous results, in turn, can cause an organization to significantly misallocate resources for direct personal promotion and/or incorrectly prioritize customers. Such misallocations and incorrect prioritization can have large financial consequences, both in increased costs and lost sales.

There are several different common approaches to determining the degree of promotion response: (1) Tracking; (2) Cross-Sectional Analysis; (3) Time Series/Marketing Mix; (4) Field Experiments; (5) Judgment. These are each discussed below.

(1) Tracking. In a tracking approach, the organization can compare actual results to budget or forecast results and attempt to reach a conclusion based on variances. Such variances do not provide promotion response since the variance may be due to errors in budget or forecasting that have little, if anything, to do with promotion response.

More often, organization will track sales results versus the amount of sales promotion and reach conclusions about the effectiveness of promotion. This, however, does not incorporate the many other activities and influences in the market that may have also impacted results. These other activities and/or influences may be partially or totally the cause of sales changes. Furthermore, these other activities and/or influences generally occur at the same time to the same customers as the sales promotion, making it difficult to determine the effect of sales promotion versus the effect of other activities or influences. This issue in calculating the promotion response effect is often referred to as multicollinearity.

For example, an organization introduces a new product using both advertising and direct promotion to help generate sales. Subsequent sales results cannot be correctly attributed to the effect of advertising, to the effect of direct promotion, or simply because of public information or news surrounding the new product introduction, because all three effects occur simultaneously and it is unknown how each separately contributes to sales.

As an additional example, the organization may decide to increase sales promotion at the same time a competitor is required to withdraw a competing product. A subsequent increase in sales cannot be correctly attributed to promotion response because it is unknown how much sales would have increased if the competitor had withdrawn its product but there had been no increase in sales promotion.

(2) Cross-Sectional Analysis. Cross sectional analysis is a more sophisticated approach, sometimes used to help overcome the problem described above, known as multi-colinearity. The approach is to analyze individual customer responses, or segments of customers, based upon the specific sales promotion each customer received, other activities that could have impacted the customer, and other influences specific to each customer. Usually a statistical procedure or technique such as multivariate regression, ANOVA, neural nets, etc. is used to analyze the data and determine the promotion response. Often the analysis is used to produce promotional response curves that purport to show how higher levels of sales promotion result in higher levels of customer response or sales.

For example, rather than analyzing aggregate sales results, the organization could analyze specific customers from 20 different cities. In some, but not all of the cities advertising was conducted, and at different levels. In some states government regulations or reimbursement policies may have been expected to impact sales. The level of sales promotion as well as sales results is also known for each customer. The analysis could include hundreds of customers, each identified with the size of the customer, an advertising level (based upon the city that the customer is in), a government policy type (based upon the state the customer is in), the amount of sales promotion, and the amount of sales of that customer. Although these variables are probably correlated (for instance more direct personal promotion was generally provided in states with better government policies) there is still substantial variation from customer to customer. A statistical procedure or process, such as multivariate regression, could then be used to estimate the effect of each activity or influence on sales.

There are several major shortcomings with the cross-sectional approach.

First, there is great difficulty in capturing all the effects and influences that might impact sales. In general, these omissions reduce the reliability of any promotion response estimate or model. If the omitted variables have large effects relative to the variables in the model, they render the results meaningless. Oftentimes the variables omitted will be correlated with direct personal promotion. In such a case, even relatively less important omitted variables will significantly distort and bias the estimate of promotion response.

For instance, if the size of the customer were omitted from the previous example, the results would probably be seriously distorted. Not only would one usually expect the size of the customer to have a significant impact on sales, one would also expect that greater sales promotion to occur with larger customers. Thus sales results are expected to be greater with larger customers, which also have greater sales promotion. Either examination of the data or statistical analysis might conclude that sales promotion was a substantial driver of sales, even if the size of the customer is a much more important determinant of sales and sales promotion had a relatively small impact.

A less obvious problem would be if direct mail had also been sent to all of the larger customers and this variable were not included in the data analysis. Analysts often do not know all of the activities, such as direct mail, that may be correlated with the direct personal promotion. These omissions will distort the promotion response estimate. Second, in many cases it is difficult to determine the time period to be covered by the model. Typically one would expect sales to occur after sales promotion, i.e., sales would lag the promotional effort. This expected lag effect could be incorporated into the analysis by simply analyzing direct promotional effort against lagged sales. However, the timing of the lag, i.e. what is the time period between the promotional effort and the sales, is usually uncertain. There is also the likelihood that promotional efforts have effects that build, or diminish over time, and it is difficult to ascribe the sale to a particular promotional effort. The time period between the promotional effort and the sale can thus vary, requiring the analyst to make some assumptions about the whether the lag between the promotional effort and the related sale is to be measured in days, weeks, or months. There is no simple method to determine these questions using the cross-sectional approach.

Third, and perhaps the most overlooked problem with cross-sectional analysis, is that there is an inherent model specification error in the analytic construct. The implicit assumption is that a change in direct personal promotion will result in a change in sales. What is overlooked is that there is usually in increase in direct personal promotion if the sales representative anticipates a change in sales.

The true model thus contains a cause and effect loop—sales increase because of an increase in sales promotion, but sales promotion is increased because the sales representative anticipates an increase in sales. Cross-sectional models are generally unable to determine the separate impact of these two distinct, but circular, causal effects, and generally ascribe both elements of the true model to sales promotion. The size and direction of the model specification error will change depending on the circumstances, thus the error cannot easily be estimated.

For example, suppose a representative identifies customers at risk of switching because of a new competitive product introduction, and increases sales promotional effort in order to defend existing sales. The increased sales promotion effort reduces the loss of existing sales at these customers, but some sales are still lost. Thus there is a positive impact of sales promotion, because the sales loss would have been worse without the sales promotion. However, a cross-sectional model will erroneously determine that there is a negative impact of sales promotion, because sales have decreased in the same accounts where there was higher sales promotion. Because of the mistaken promotional response measurement, the organization may then direct sales representatives to reduce efforts at these accounts (perhaps by changing the prioritized list) or generally reduce resource allocation to sales promotion. This change in prioritization or resource allocation would then exacerbate the sales decline.

This third problem, model specification error, is of special concern in measuring the promotional response of sales promotion. In a sales promotion system as has been described one can generally expect the representative to target greater efforts toward customers that they anticipate will generate greater sales. Thus, in any sales promotion system in which the representative has some latitude in making sales promotion, one can expect a significant model specification error. This would generally include almost all situations where a direct sales or service force is utilized.

The common approach of lagging sales in the analysis cannot solve this problem. This procedure does not eliminate the cause and effect loop because the sales representative is anticipating future sales changes. The timing of the lagged sales effect of direct promotion would generally be expected to be about the same as the sales timing lead of the sales representative.

The model specification problem can be treated if the analyst can isolate the increased effort given by the representative because of the anticipated sales. For instance, instrumental variables that estimate the sales representative targeting effect could be utilized in a 2-stage or 3-stage least square models to accurately determine the sales promotional response. Unfortunately, it is usually highly impractical, and often impossible, to quantitatively isolate this component.

Thus model specification error remains a key unsolved challenge of the cross-sectional approach.

(3)Time Series/Marketing Mix—In the time series/marketing mix approach, the analyst studies the change in aggregate sales versus aggregated sales promotion over time, instead of analyzing the promotional effect across customers (cross-sectional analysis). This approach cannot determine customer prioritization, because data for all customers are aggregated, but the approach purports to determine the sales promotion response of the aggregate sales promotion effort.

In the time series/marketing mix approach, sales, as well as all suspected influencers upon sales, are recorded at all time periods. For instance, the model might be based on monthly data during the last 48 months. For each time period aggregates sales, aggregate sales promotion, and any other variables that might predict or influence sales are recorded. These other variables can include seasonal influences (e.g. sales are higher in spring, etc.), competitive activity (e.g. competitor's aggregated sales promotion, etc.), general economic indicators (e.g. GNP, interest rates, etc.), product changes, unusual events (e.g. strikes), and other variables anticipated to impact sales (e.g. advertising, price, etc.). The lagged effect of many of these variables is explicitly modeled so that the analysis is able to determine how the magnitude of any lagged effect varies over time. It is also possible to divide the aggregate market into multiple segments and separately analyze each segment.

Because the time-series approach generally aggregates all data within a time period, many of the problems that occur in cross-sectional analysis because key data is omitted at an account level are significantly reduced. The model-specification error issue is also reduced because the aggregation of data eliminates the account level targeting done by the sales representative.

However, these two problems are not eliminated, and, in practice, may result in just as serious errors. The key problem remains that there may be a reason that aggregate sales promotion changes from period to period, but this reason is mistakenly excluded from the model. If this excluded reason is correlated with sales, then the promotional response measurement will be erroneous.

For example, a sales force may be directed to increase sales promotion efforts just before major holidays in anticipation of greater sales. The resulting sales effect is partially the result of the increased direct promotion, but also because of the holiday. If these holidays are not explicitly included in the model, the result will be to erroneously incorporate the holiday effect into the direct promotion.

The practical problem of including all the correct influencing factors is particularly difficult in time series models because they are often based on data that is several years old. The reason that direct personal promotion was changed in early periods of the model is often forgotten. Those reasons, however, can be quite important in the promotional response measurement. For instance, direct promotion may have been increased during early periods of the model in order to exploit a temporary sales advantage—perhaps a competitor had an unusually high number of product problems—that has since been forgotten. If a variable is not incorporated that represents this temporary sales advantage, the time series/marketing mix model will give erroneous results.

The time series approach also suffers in that it utilizes dated information in the model. It is highly questionable if the promotional response of the current market should be based on analysis of data much of which is more than a year out-of-date.

(4) Field Experiments—In a field experiment approach, the analyst conducts a field experiment rather than relying on historical data. The amount of sales promotion is altered in several test sales geographies or territories. The subsequent sales results are compared between the test territories and corresponding control territories. Field experiments are often used to measure overall sales promotion response, but can also be used to test alternative customer prioritization.

In theory, field experiments should overcome most of the problems encountered with the methods described previously (tracking, cross-sectional, and time series/marketing mix). In practice, however, field experiments prove difficult to execute and unreliable.

The largest practical problem is that the field experiment directly impacts the representatives in many ways other than the effect that is to be measured. Usually the field sales management and representatives will be aware of the test, and/or will recognize a significant change in the prioritized list accompanying the test. The mere existence of the test usually creates significant uncertainty and concern among the sales organization, particularly if compensation or career progression is based on results.

Depending on the situation, then, the sales force is likely to behave differently in the test markets than what would normally be expected. It is likely that representatives in a test will not follow guidance regarding targeting and/or resource allocation as might usually be expected. In extreme situations representatives in test markets may ignore the guidance and/or falsify records regarding sales promotion activity. Thus any differences between test and control geographies cannot be ascribed to the difference in direct promotional effort, it may be an unwanted byproduct of the test itself.

Furthermore, while there are usually great efforts made to select test and control markets that are statistically similar to one another, after the test begins there will often be unanticipated differences between the test and control markets that essentially invalidate or confound the test. For example, a competitor may introduce a new product in one of the test markets, thus making it completely inappropriate to compare the test market against control markets that do not have a new product introduction.

Lastly, the implementation of field experiments is usually difficult. This is because of the need to inform numerous people in the sales and service organization about the specifics of the plan.

(5) Judgment—In a judgment approach, the organization can use opinions of managers, recognized experts, experience executives, etc. to estimate the sales promotion response. This may be simply expressed as an estimate that sales will increase a certain percent over the next year if the sales or service force is increased by a certain percent. However this judgment is expressed or incorporated into the organizations decision, it is difficult, if not impossible, to determine if this judgment is quantitatively accurate. Judgment is not only unreliable; it is often biased based upon the experience and objectives of the individual providing the judgment.

Thus all common approaches to measuring the promotional impact of direct personal promotion are found to be erroneous, unreliable, and/or difficult to implement.

### SUMMARY OF INVENTION

The invention is a new methodology for measuring the promotional impact of sales promotion efforts.

The invention provides promotional response measurement that is not prone to common problems of omitted variables and model specification error. Further, the invention not only provides aggregate response measurement, but also measures response against specific segments of customers. Such results can be used to reprioritize customers and/or change sales promotion resource allocation to customers. The invention provides unbiased response estimates that can be used to compare the promotional response of multiple products. Thus the results can also be used to change the resource allocation between products. The invention is relatively easy to implement. Typically it makes use of the existing systems to provide customer priority to representatives, and generally does not create unwanted test effects common to most experimental approaches. Results are based on a relatively recent market environment and the measurement is not biased or distorted due to unanticipated changes in the market during the measurement period. The method also measures how sales representatives respond to revised prioritized lists of customers.

The methodology generally utilizes an existing customer prioritization system. Adjustments are made in the prioritized list provided to representatives so that the impact of alternative prioritization or resource allocation is simulated without significantly impacting current sales promotion activity. Subsequent sales results are compared between the unadjusted and adjusted customers on the prioritized list. This difference is used to calculate the promotional response.

Typically the number of upward and downward adjustments made to the targeting and/or resource allocation guidance given to sales representatives are balanced so that there is little net change in overall anticipated sales promotion. Typically the number of adjustments will be a small proportion of the total customer list thus ensuring that the impact of the adjustments on existing sales activities will be relatively small.

The adjustments are typically randomized. These virtually eliminates the possibility that key variables, which might be excluded from a targeting, cross-sectional, or time-series/marketing mix analysis, will be correlated with the adjustments and therefore significantly interfere with the promotional response measurement. It is also possible to stratify the adjustments across a few key variables, which are anticipated to be heavily correlated with promotion response, to ensure that both the adjusted and unadjusted customers will have virtually identical means and standard deviations on the key variables. Such stratification is used to minimize the statistical difference between the adjusted and unadjusted customers.

Unlike typical field experiments, these adjustments are distributed across the all geographies and sales representatives. This virtually eliminates any possibility of unique regional or geographic factors that will significantly bias results.

Furthermore, the randomization ensures that the impact of the adjustments will be small for any given sales representative. This significantly reduces unwanted test effects. In many cases sales representatives will be unaware and unable to detect the specific adjustments.

The method can be modified to enable the organization to test revised targeting or resource allocation. A proportion of customers, randomly chosen, are prioritized based on revised targeting, while the remainder are prioritized using existing targeting. Subsequent analysis of sales determines the effectiveness of the revised targeting approach.

### BRIEF DESCRIPTION OF THE DRAWINGS

FIG. 1 is an illustration of the steps of the method of the present invention as applied in the context of pharmaceutical marketing using sales representatives assigned in a call planning system.

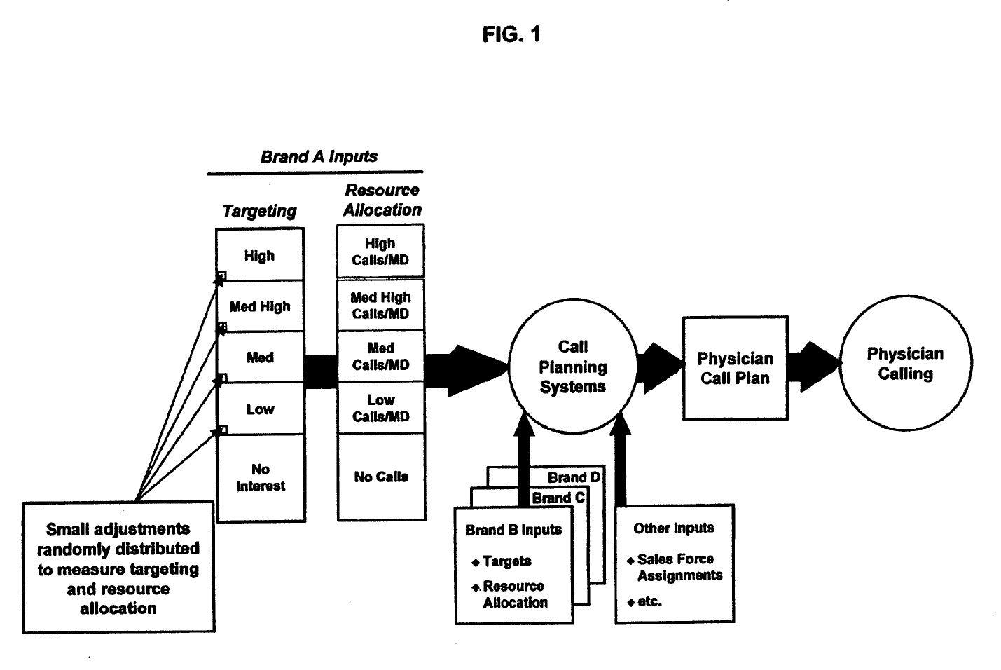

FIG. 2 is illustration of one example of the implementation of a change in the call planning system in accordance with the method of the invention.

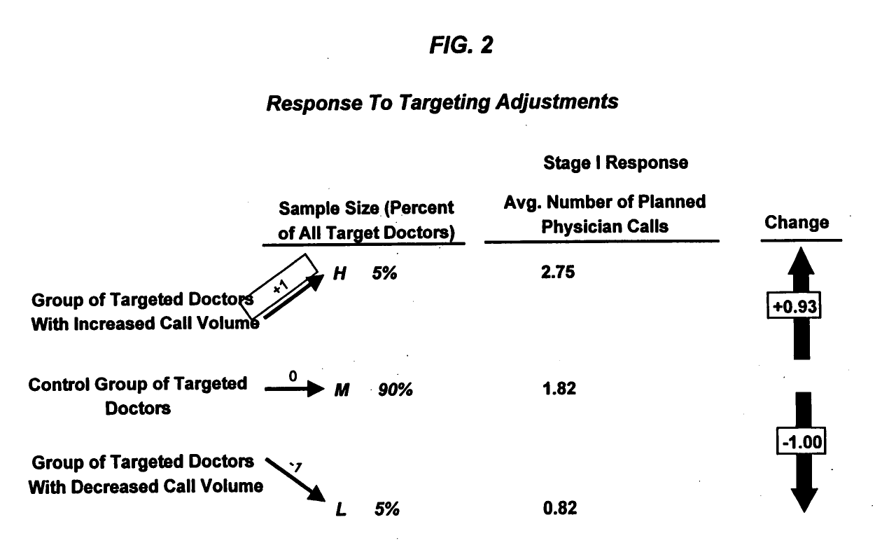

FIG. 3 is an illustration of the use of results obtained by the method of the invention to incrementally enhance sales call effectiveness.

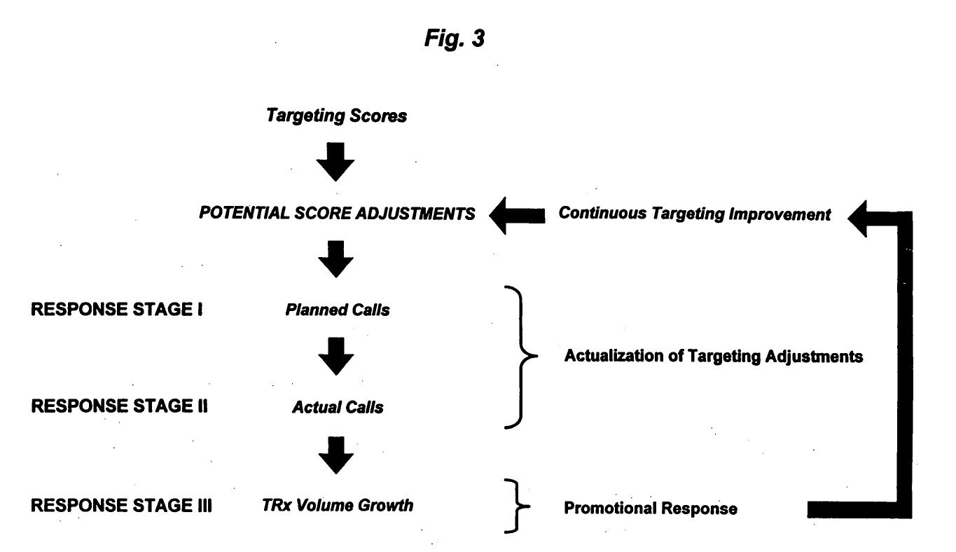

### DETAILED DESCRIPTION OF THE PREFERRED EMBODIMENT

In a typical selling allocation system, the organization determines the priority of customers and also determines the level of resource allocation provided to the prioritized list. Customers with high priority are typically given greater resource allocation.

The methodology is to adjust the priority of a random selection of customers such that the corresponding resource allocation is either increased or decreased. The revisions may be incorporated into a relatively sophisticated system that then provides representatives with detailed sales promotion guidance by customer, or may be communicated to the sales representatives directly simply as prioritized lists of customers. Sales results, and if possible sales promotion effort, is measured for specific customers.

Subsequent sales promotional effort is measured for the adjusted accounts versus the unadjusted accounts. This enables the analyst to measure the response of the sales representative to the suggested prioritized list. This new measurement concept has not been considered in prior measurement approaches. Sales results are also measured for the adjusted accounts versus the unadjusted accounts.

The change in sales can be compared with the actual change in promotion, or compared with the anticipated change in promotion implied in the upward and downward adjustments. Depending on the situation, either, or both of these measurements may be used to revise targeting and/or resource allocation. For example, if a change in targeting priority is contemplated (but the total number of sales representatives will remain unchanged), it is usually more appropriate to measure the sales promotional response versus the suggested changes in priority. On the other hand, if the targeting priority was to remain the same, but an increase in effort was to be achieved by increasing the number of sales representatives, it would be more appropriate to measure the sales promotional response versus the actual change in direct promotion.

In some situations there are a total of three types, or stages, or response that can be measured; (1) the change in sales (or other suitable objective) of the customer, (2) the change in selling activity (or other suitable objective) of the sales representative, and (3) the change in the sales instructions, guidance, or direction giving to the sales representatives.

This third response typically applies in situations where a selling allocation system uses multiple inputs regarding the priority of customers and the amount of effort to be applied, and produces a recommended call frequency to specific customers for sales representatives. One example might be a pharmaceutical company that uses a sales allocation system to provide a sales force with specific call frequency objectives for specific doctors for multiple brands of drugs based upon a number of inputs. The described system enables one to measure how changes in account priority for a given brand results in a new recommended call frequency, without requiring the company to rerun the entire sales allocation system.

The number of customers randomized depends upon the degree of statistical accuracy desired in the measurement. A greater number of customers increases statistical accuracy, that is, the amount of promotion that can be statistically measured. Following common statistical guidelines, generally in order to reduce the statistical accuracy by one-half, the number of customers must be increased by a factor of four, essentially following an inverse square relationship. Measurement also depends on the variability of sales results. High variability creates higher standard deviation and reduces statistical certainty.

Typically the organization will want to minimize the number of adjustments in order to minimize the impact on current activities. Thus there is a tradeoff between statistical measurement accuracy and impact on the business. If the promotion response effect is expected to be small, the number of adjustments can be increased without significantly impacting the business. Conversely, if the promotion response effect is expected to be large, then fewer adjustments will be required to achieve a valid measurement. In many situations the pragmatic choice will be to start with a small number of adjustments and begin to read the promotional response over time. If there is initially very little response, it is then appropriate to increase the number of adjustments. Note that the results of the two different sets of adjustments cannot typically be directly combined and analyzed together because they are started at different time periods.

As with the number of adjustments, the size of the adjustments has statistical and business impact tradeoff. Typically the adjustments will be kept relatively small so as to minimize business disruption. Furthermore, assuming that the customer prioritization resource allocation system is reasonable correct to begin with, measuring incremental adjustments are more consistent with the types of changes that will typically be contemplated as a result of promotion measurement.

Measurement is conducted over time, and may be continued even after discontinuation of the adjustments. Sales effects can be trended to better gauge the timing of lagged sales promotion effects, or aggregated to increase statistical measurement certainty. In general, a smaller number of adjustments will require greater time to achieve statistical measurement.

Statistical measurement can be made using simple t-test of means between upward, downward, and unadjusted groups. Comparison of the upward versus the downward adjustments can be used to detect sales effects that might not be statistically measurable by comparing either upward or downward groups against the unadjusted customers. ANOVA or other advanced techniques can be utilized to enable inclusions of co-variates that might be anticipated to affect the results, but more importantly, better facilitate response measurement by segments.

Customers can be segmented by many different criteria and still obtain valid measurements. For instance, the promotional response can be compared between customers in the East vs. the West, or promotional response can be compared between customers that have high vs. low competitor share. However, customers cannot be segmented and promotional response reliably measured based upon sales activity. That is, customers cannot be segmented based on number of sales contacts, or whether sales representatives made more, or fewer, contacts than suggested in the list. Such segmentation would create a model specification error previously discussed.

Measurement of results by segment can be used to adjust the prioritization of the customers. If customers in one segment provide higher promotional response, these customers can be given an upward adjustment in the targeting priority.

It is also possible to measure by segments based upon the suggested resource allocation and/or targeting priority. If, for example, medium priority customers typically are to receive an average of 4 calls per quarter and have higher promotional response than high priority customers, which typically are to receive an average of 8 calls per quarter, then the resource effort against medium priority customers can be adjusted upward relative to the high priority customers. Note that in this example, if segment specific analysis confirmed that the customer priority was correct, then high priority customers should still get more calls than medium priority, but the relative effort of 8 and 4 calls per quarter, respectively, might be altered to 7 and 5 calls per quarter.

Overall promotional response, combined with appropriate financial assumptions and calculations, can be used to determine if overall sales promotion should be altered or shifted to other products. It will be appreciated that these assumptions and calculations can change considerably based upon the situation.

The specific customers to be adjusted are selected at random. This is to ensure that there is no hidden bias in the selection of customers that could impact promotional response of the customers. This also ensures that unusual occurrences or activities will also be randomly distributed between the adjusted and unadjusted customers, and therefore, not create a bias in measurement.

In general, the adjusted customers should not be adjusted for any other sales, service, or marketing activities. This would create colinearity between other activities and the sales promotion activity. If the customers are adjusted for other activities, any differential activity so given should be recorded and included as a covariate in the analysis.

For statistical validity, a similar set of customers can be selected at random that are not adjusted. Since no statistically significant change in sales is anticipated due to sales promotion, because there is no change in sales promotion suggested or implied in the prioritized customer lists, this group of customers can also be measured. This group should have not have a statistically significant promotion response.

The randomization can be stratified to reduce potential statistical variance, and therefore improve readability of results. For instance, the randomization can be stratified to ensure that large, medium, and small customers are appropriately represented in the adjusted group. Stratification can even be used to over represent some customer types in the adjustments in order to increase statistical readability of that segment, however caution must be used in analysis if some segments of customers are deliberately over or under represented in the adjustment group. Also note that overuse of stratification may give rise to other biases or issues that are not easily detected.

Often the priorities of customers or resource allocation may change during the course of the measurement. This poses no special problem, however, it may create a greater amount of statistical variability in results that will reduce the accuracy of the measurement. Typically the adjustments will continue even with the new priorities—the same adjustment being made for the same specific customers even as the underlying priorities or resource allocation are altered.

The following example illustrates the use of the invention.

A pharmaceutical company has a sales force of 500 representatives selling 3 different drugs to a market of 75,000 physicians. The company uses a contact planning system that provides each representative with a complete list of physicians in his/her territory and a recommended contact frequency for each of the three drugs for each physician on the list. The contact plan is updated each month and includes information about each physician, including the number of contacts that have been made to that physician. Thus the representative can track progress in terms of contacts and sales to each physician.

For one of the three drugs, drug Alpha, the 75,000 physicians have been prioritized from the most important physicians to contact to the least important physicians to contact. This ranking has been divided into 7 different categories, from “Very High” to “Very Low” reflecting the desired number of contacts that are wanted for each physician as indicated in Table 1:

TABLE 1

| | | Desired Contacts | Total |
|---|---|---|---|
| Drug Alpha | Number of | Per Year per | Contacts |
| Priority | Physicians | Physician | per Year |
| Very High | 0 | 30 | 0 |
| High | 15,000 | 24 | 360,000 |
| Med High | 15,000 | 18 | 270,000 |
| Medium | 15,000 | 12 | 180,000 |
| Med Low | 15,000 | 6 | 90,000 |
| Low | 15,000 | 4 | 60,000 |
| Very Low | 0 | 2 | 0 |
| Sum | 75,000 | | 960,000 |

The total contacts desired would require each sales representative to make 9 to 10 contacts per day, assuming 200 days per year are available to make contacts.

Note that the contact planning system must combine similar inputs from the other two drugs the representatives also sell. These other drugs have a different physician ranking and different desired contacts per year. Because of the contact plan must sometimes arbitrate conflicts in physician priority or resource allocation across the three drugs, the resulting contact plan will not have exactly the requested contacts for each physician. But, on average, “High” doctors for drug Alpha will have a planned contact frequency of approximately 24 contacts per year, the other rankings will have the indicated planned contact frequencies.

Note also that the representatives do not contact each physician exactly as suggested in the contact plan. Although the average will be approximately the desired number of contacts per year, the actual contacts per physician will vary considerably with many being over 50% higher, and many being 50% lower, than the desired number of contacts.

To determine the promotional responsiveness from contacts the adjustments illustrated in Table 2 are implemented. 500 physicians, or 3.3%, of each priority group of physicians are adjusted to the next higher priority level. Another 500 physicians of each group priority level are adjusted down one level. The adjusted physicians are chosen at random from with the priority groups. No priority is changed more than one level. In this example the desired contacts remains the same for each priority level.

TABLE 2

| | Physician Counts | | | | | | |
|---|---|---|---|---|---|---|---|
| | | Adjusted Up | Adjusted | | | Desired | |
| | | from | Down from | | | Contacts Per | Revised |
| Drug Alpha | Original | Lower | Higher | Not | Revised | Year per | Contacts |
| Priority | Priority | Priority | Priority | Adjusted | Priority | Physician | per Year |
| Very High | 0 | 500 | | | 500 | 30 | 15,000 |
| High | 15,000 | 500 | | 14,000 | 14,500 | 24 | 348,000 |
| Med High | 15,000 | 500 | 500 | 14,000 | 15,000 | 18 | 270,000 |
| Medium | 15,000 | 500 | 500 | 14,000 | 15,000 | 12 | 180,000 |
| Med Low | 15,000 | 500 | 500 | 14,000 | 15,000 | 6 | 90,000 |
| Low | 15,000 | | 500 | 14,000 | 14,500 | 4 | 58,000 |
| Very Low | 0 | | 500 | | 500 | 2 | 1,000 |
| Sum | 75,000 | 2,500 | 2,500 | 70,000 | 75,000 | | 962,000 |

This provides a total adjusted group of 5,000 physicians. Each representative has, on average, 5 physicians that are moved up one level and 5 physicians that are moved down one level. This compares against an average of 150 physicians per representative. Total desired annual contacts have changed only slightly from 960,000 to 962,000, an increase of 0.2%.

The first question is to determine how the contact allocation system changes the contact plan in response to these adjustments. This is done using the response measurement methodology, and does not require re-running the contact planning system with different assumptions. Table 3 below provides the average planned contacts for each adjustment cell, up and down, and for the unadjusted physicians.

TABLE 3

| | | Adjusted Up | | Adjusted Down | | Not Adjusted | | |
|---|---|---|---|---|---|---|---|---|
| | Desired | | Avg. | | Avg. | | Avg. | Total |
| | Contacts Per | | Planned | | Planned | | Planned | Planned |
| Drug Alpha | Year per | | Contacts | | Contacts per | | Contacts | Contacts |
| Priority | Physician | Physicians | per Year | Physicians | Year | Physicians | per Year | per Year |
| Very High | 30 | 500 | 29.5 | | | | | 14,750 |
| High | 24 | 500 | 23.2 | | | 14,000 | 24.1 | 349,000 |
| Med High | 18 | 500 | 16.9 | 500 | 19.2 | 14,000 | 17.9 | 268,650 |
| Medium | 12 | 500 | 10.8 | 500 | 13.1 | 14,000 | 11.9 | 178,550 |
| Med Low | 6 | 500 | 5.9 | 500 | 7.2 | 14,000 | 6.1 | 91,950 |
| Low | 4 | | | 500 | 4.5 | 14,000 | 4.0 | 58,250 |
| Very Low | 2 | | | 500 | 3.0 | | | 1,500 |
| Sum | | 2,500 | | 2,500 | | 70,000 | | 962,650 |

| | | | |
|---|---|---|---|
| Weighted Average Desired | 18.0 | 8.4 | 12.8 |
| Weighted Average Planned | 17.3 | 9.4 | 12.8 |

As can be seen, the total number of planned contacts is again very near the target of 960,000, and that the average planned contact frequency for each of the unadjusted physicians is also very near the desired contacts per year per physician. Also, it should be noted that all physicians that were adjusted up have an increase in planned contacts versus the unadjusted group, but not quite as high as the desired number of contacts in the revised target level. The desired average contacts for the “Up” group is 18.0. If they had been left at the old priority, the desired average would have been 12.8. The actual planned contacts are 17.3. In essence, for a requested increase of 5.2 (from 12.8 to 18.0), the planned contacts are increased 4.5 (from 12.8 to 17.3). Thus the planning system is responding, providing approximately 4.5 planned contacts for every 5.2 requested implied by the revised priority ranking, or a response rate of 87%.

In a similar manner the contact planning system is reducing planned contacts for the adjusted down group. In this and subsequent illustrations statistical confidence levels are not provided. In this table assume that all results have standard errors on the order of 0.05 contacts, thus these results are statistically significant. In actual practice the statistical confidence should be incorporated rigorously into all analyses.

The next level of promotion response is to measure how representatives respond to the revised targeting direction. Table 4 below shows the actual contact frequency for a three month period after the adjustments are implemented and the revised contact plan is provided to the field (contact frequency is still reported at an annual rate even though it is for a three month period).

TABLE 4

| | | Adjusted Up | | Adjusted Down | | Not Adjusted | | |
|---|---|---|---|---|---|---|---|---|
| | Desired | | Avg. | | Avg. | | Avg. | Total |
| | Contacts | | ACTUAL | | ACTUAL | | ACTUAL | Planned |
| Drug Alpha | Per Year per | | Contacts | | Contacts | | Contacts | Contacts |
| Priority | Physician | Physicians | per Year | Physicians | per Year | Physicians | per Year | per Year |
| Very High | 30 | 500 | 29.0 | | | | | 14,500 |
| High | 24 | 500 | 22.0 | | | 14,000 | 23.9 | 345,600 |
| Med High | 18 | 500 | 16.5 | 500 | 19.4 | 14,000 | 18.0 | 269,950 |
| Medium | 12 | 500 | 10.7 | 500 | 13.2 | 14,000 | 12.1 | 181,350 |
| Med Low | 6 | 500 | 5.1 | 500 | 7.3 | 14,000 | 6.1 | 91,600 |
| Low | 4 | | | 500 | 4.7 | 14,000 | 4.2 | 61,150 |
| Very Low | 2 | | | 500 | 2.5 | | | 1,250 |
| Sum | | 2,500 | | 2,500 | | 70,000 | | 965,400 |

| | | | |
|---|---|---|---|
| Weighted Average Desired | 18.0 | 8.4 | 12.8 |
| Weighted Average ACTUAL | 16.7 | 9.4 | 12.9 |

For purposes of this example, the table and comparisons are made versus the desired contacts per year. This comparison provides understanding about how actual contacts will change in response to changes in targeting priority. A separate analysis, not illustrated here, could compare actual contacts versus planned contacts. This would provide the actual contact change in response to a revised contact plan. The appropriateness. of the each of the two comparisons depends upon the specific business objective and/or issue to be considered.

Similar to the prior discussion, the table shows an increase in contacts in the “Up” group of 3.8 (from 12.9 actual in the unadjusted group to 16.7 in the “Up” group). This compares to the “desired” increase of 5.2 contacts (from 12.8 to 18.0). Thus actual contacts delivered are about 72% (3.8 over 5.2) of what might be anticipated due to the revisions.

There are probably many different reasons why this response rate is only 72%. First, note that the contact planning system, previously discussed, had a response of 87%. It is logical to conclude that a part of the reason delivered contacts are only 72% is because the contact system did not request all the contacts that were implied by the targeting adjustments. It would probably be appropriate to conclude that the representatives delivered approximately 83% of requested contact increases (72% actual vs. desired divided by 87% planned vs. desired).

The contact response rate may also be low because the representatives have not yet fully adjusted to the revised contact plan. Even though a new plan is provided each month, representatives will typically already have a number of appointments and commitments consistent with the old contact plan. One might expect the contact response to be smaller in the first month and then plateau to new contact frequency over the subsequent months. Analyses could be conducted that examine the response differences by month.

Another reason might include a natural resistance of the representative to adjust contact frequencies that the representative believes are inappropriate. This is not to suggest that representative have separately analyzed the adjusted versus the unadjusted physicians. The representative should be unaware of which physicians are adjusted.

However, if the original targeting priority is optimal and the representative alters the actual contact frequency for each physician to reflect that physician's opportunity for increased sales, then representatives will tend to contact less than the requested increase if the targets have been raised in priority too high, and will tend to contact more than requested if the targets have been adjusted too low. Note that because the adjustments are a small percent of all physicians, the adjustments are only one level, representatives will tend to counterbalance the requested contact frequency if the adjustments are too high or too low, and typically there is a declining promotional response on incremental contacts, the impact of these adjustments on sales will typically be quite small.

Typically the primary interest of the methodology will be the sales response. Table 5, below, illustrates the actual increase in sales units compared with the actual contact frequency. Thus, the contact frequencies in this table are identical to the previous table. As noted previously, the comparison could also be made between sales response and desired contact frequency, or sales response and planned contact frequency. The appropriateness of each comparison depends upon the business objectives and issues.

Note that there has been an increase in contacts in the “Up” group and there has also be an increase in sales. Correspondingly, the “Down” group shows a decrease in contacts and a decrease in sales. Thus the methodology has determined that there is a positive promotional response to contacts. Also note that the total change in sales is very small. The “Up” group shows an average unit increase of 3.5 (25.7 up to 29.2), but this is offset by the “Down” group showing a decrease of 3.7 (25.7 down to 22.0). The total change in sales attributable to the adjustments is a decrease of 500 units (3.5 times 2,500 physicians less 3.7 times 2,500 physicians) against total sales of 1,927,000 units —or 0.026%.

TABLE 5

| | Adjusted Up | | | Adjusted Down | | | Not Adjusted | | |
|---|---|---|---|---|---|---|---|---|---|
| | | Avg. | | | Avg. | | | Avg. | |
| | | ACTUAL | | | ACTUAL | | | ACTUAL | Average |
| Drug | | Contacts | Average | | Contacts per | Average | | Contacts | Sales |
| Alpha Priority | Physicians | per Year | Sales Units | Physicians | Year | Sales Units | Physicians | per Year | Units |
| Very High | 500 | 29.0 | 50.7 | | | | | | |
| High | 500 | 22.0 | 43.6 | | | | 14,000 | 23.9 | 47.7 |
| Med High | 500 | 16.5 | 28.7 | 500 | 19.4 | 45.2 | 14,000 | 18.0 | 36.0 |
| Medium | 500 | 10.7 | 14.4 | 500 | 13.2 | 26.1 | 14,000 | 12.1 | 24.2 |
| Med Low | 500 | 5.1 | 8.8 | 500 | 7.3 | 19.6 | 14,000 | 6.1 | 12.2 |
| Low | | | | 500 | 4.7 | 11.6 | 14,000 | 4.2 | 8.4 |
| Very Low | | | | 500 | 2.5 | 7.6 | | | |
| Sum | 2,500 | | | 2,500 | | | 70,000 | | |

| | | | | | | |
|---|---|---|---|---|---|---|
| Weighted Avg. ACTUAL | 16.7 | 29.2 | 9.4 | 22.0 | 12.9 | 25.7 |

As illustrated in Table 6 below, the information in the above table can be condensed and rearranged to focus on the differences between the adjustment groups and the unadjusted groups. In this table all changes are listed versus the original targeting groups.

TABLE 6

| | Adjusted Up | | | Adjusted Down | | |
|---|---|---|---|---|---|---|
| Drug Alpha | Avgerage | Average | | Avgerage | | |
| Priority | CHANGE | CHANGE | | CHANGE | Average | |
| PRE- | in | in Sales | | in | CHANGE in | |
| Adjustment | Contacts | Units | Response | Contacts | Sales Units | Response |
| Very High | | | | | | |
| High | 5.1 | 3.1 | 60% | (4.5) | (2.4) | 54% |
| Med High | 4.0 | 7.7 | 192% | (4.8) | (9.8) | 205% |
| Medium | 4.4 | 4.6 | 104% | (4.8) | (4.6) | 95% |
| Med Low | 4.6 | 2.2 | 47% | (1.4) | (0.6) | 41% |
| Low | 0.9 | 0.4 | 43% | (1.7) | (0.8) | 48% |
| Very Low | | | | | | |
| Avg. | 3.8 | 3.6 | 94% | −3.4 | −3.7 | 106% |

Note that the “Up” group generates an increase of 0.94 units for every incremental contact. The “Down” group loses 1.06 units for an every incremental decrease in contacts. Thus, we can generally expect to generate about one additional unit in sales for every additional contact.

Importantly, however, this data reveals that the response rate is much higher for the Med-High target group. High, Med-Low, and Low groups typically have an incremental response rate in the 50% range, significantly below the average. The Med-High group generates incremental response at approximately 200%.

This result suggests that the contact frequency should be increased for the Med-High group relative to the High, Med-Low, and Low groups. A suitable adjustment might be to adjust the desired contact frequency up by 3 contacts in the Med-High group, and decrease the desired contact frequency by 1 contact in the High, Med-Low, and Low groups.

Based upon the calculated response rates this would generate an increase of approximately 90,000 units in the Med-High group (3 increased contacts times 200% response times 15,000 physicians) partially offset by approximately 22,500 units in the other three groups (1 decreased contact times 50% response times 45,000 physicians). This net increase of 67,500 units is achieved without any net change in contacts, and therefore no change in sales cost, and is 135 times larger than the 500 units that were forfeited due to the test.

As discussed previously with contact response, sales response would also normally be expected to lag increase in contacts. Although not illustrated, the analysis should be extended to examine the change in sales over time, etc.

Further, the unit sales results illustrated above, coupled with appropriate financial assumptions, such and revenue per unit, margin, cost per contact, etc, and assumptions or results regarding the response effect over time, can be used to determine the profitability of increased contacts. Based upon results of these analyses, the organization may decide to shift additional resources to or from Product Alpha, from sales contacts assigned to the other two products, based upon the relative profitability of the three products. Such analyses may also be used to decide to increase, or decrease contact efforts in aggregate for the 3 products.

The tables provided only show analysis with physicians segmented by targeting group. Although not illustrated, it is also possible to conduct similar analysis on other segmentation criteria.

For example, physicians could be segmented based upon the physicians specialty—perhaps separating physicians into 4 specialty segments; Cardiology, Internal Medicine, Family Practice and General Practice, and Obstetrics and Gynecology. Response analysis by segment may reveal that Internal Medicine physicians generate a greater incremental response to contacts, regardless of the targeting priority they are given.

This result would suggest that the Internal Medicine doctors, in general, should be given higher priority in the targeting. Combined with the other criteria that gave rise to the original targeting, this would tend to move many Internal Medicine doctors up in priority, and result in these doctors being given more contacts. This segment driven targeting adjustment would be done in addition to the contact frequency adjustment discussed previously.

In summary, the present invention provides a method of and software for determining effectiveness of direct personal promotion efforts in a marketing environment in which representatives make contact with a customer in accordance with a prioritized list, comprising the steps of: (1) creating on a computer an electronic prioritized list of customers for representatives of an organization to use in contacting customers, the electronic prioritized list including an identification of a customer identity and a specified contact frequency for each such customer to be executed by the representatives; (2) adjusting the specified contact frequency for a selected subset of customers on said electronic prioritized list to create an electronic adjusted prioritized list; (3) communicating the electronic adjusted prioritized list to the representatives (e.g. by generating call lists for each representative or groups of representatives); and (4) measuring changes in the promotional response among the selected subset of customers and recording data relating to said changes in an electronic data storage system. The invention further include a method of improving effectiveness of such direct personal promotion efforts by a further step of using the measured change in promotional response among the selected subset of customers as an input to creation of an updated electronic prioritized list with a modified contact frequency targeting the customers most likely to yield additional sales. In the case of pharmaceutical marketing, such additional sales are generated by the physician's decision to prescribe a marketed drug; but in other contexts the customer may themselves purchase a product or service for their own consumption, or may purchase the product or service for resale to a consumer, or the call may be a service call that will yield improved customer satisfaction.

It will be appreciated that the present invention is not limited to the analyses and situation and description provided above. Other statistical procedures can be utilized to extend the power and insight gleaned from the results as well as provide additional guidance for the organization regarding targeting and resource allocation. Also, there are potential extensions of the methodology to test other promotion response questions and using the data derived from the measurement with other data mining or statistical techniques, such as neural nets, to improve targeting guidance.

What is claimed is:

1. A method of determining effectiveness of direct personal promotion efforts in a marketing environment in which sales representatives make contact with a customer in accordance with a prioritized suggested list, comprising the steps of:
creating on a computer an electronic prioritized suggested list of customers for sales representatives of an organization to use in contacting customers, said sales representative having the ability to alter the specified contact frequency, said electronic prioritized suggested list including an identification of a customer identity and a specified contact frequency for each such customer to be executed by said sales representatives;
adjusting the specified contact frequency for a selected subset of customers to create an electronic adjusted prioritized suggested list with an adjusted specified contact frequency, said adjustment of specified contact frequency for a selected subset of customers in said adjusted prioritized suggested list being incremental such that the sales representatives are unaware of the adjustment of specified contact frequency;
communicating said electronic adjusted prioritized suggested list to said sales representatives;
measuring changes in the promotional response among said selected subset of customers and recording data relating to said changes in an electronic data storage system.

2. A method of determining effectiveness of direct personal promotion efforts in a marketing environment in accordance with claim 1, wherein said step of adjusting the specified contact frequency comprises increasing a quantity of contacts made with said selected subset of customers in a specified time period.

3. A method of determining effectiveness of direct personal promotion efforts in a marketing environment in accordance with claim 1, wherein said step of adjusting the specified contact frequency comprises decreasing a quantity of contacts made with said selected subset of customers in a specified time period.

4. A method of determining effectiveness of direct personal promotion efforts in a marketing environment in accordance with claim 1, wherein said step of adjusting the specified contact frequency comprises increasing a quantity of contacts made with a first group of identified customers within said selected subset of customers and decreasing a quantity of contacts made with a second group of identified customers within said selected subset of customers.

5. A method of determining effectiveness of direct personal promotion efforts in a marketing environment in accordance with claim 1, further comprising:
measuring changes in actual contacts by said sales representatives with said selected subset of customers.

6. A method of determining effectiveness of direct personal promotion efforts in a marketing environment in accordance with claim 1, further comprising: using a measured change in promotional response among said selected subset of customers as an input to creation of an updated prioritized suggested list specifying a modified contact frequency for certain customers.

7. A method of determining effectiveness of direct personal promotion efforts in a marketing environment in accordance with claim 6, further comprising: using a measured increase in promotional response among said selected subset of customers as an input to creation of an updated prioritized suggested list specifying a modified contact frequency applicable to customers contained in one or more first target groups of customers.

8. A method of determining effectiveness of direct personal promotion efforts in a marketing environment in accordance with claim 6, further comprising: using a measured decrease in promotional response among said selected subset of customers as an input to creation of an updated prioritized suggested list with a modified contact frequency applicable to customers contained in one or more second target groups of customers.

9. A method of determining effectiveness of direct personal promotion efforts in a marketing environment in which sales representatives make contact with a customer in accordance with a prioritized suggested list, comprising the steps of:
creating on a computer an electronic prioritized suggested list of customers for sales representatives of an organization to use in contacting customers, said sales representatives having the ability to alter the specified contact frequency, said prioritized suggested list including an identification of a customer identity and a specified contact frequency for each such customer;
adjusting the specified contact frequency for a selected subset of customers to create an adjusted electronic prioritized suggested list, a variance between said prioritized suggested list and said adjusted electronic prioritized suggested list being undistinguishable to said sales representatives;
communicating said adjusted electronic prioritized suggested list to said sales representatives;
measuring changes in the promotional response among said selected subset of customers;
using a measured change in promotional response among said selected subset of customers as an input to creation of an updated electronic prioritized suggested list with a modified contact frequency increasing contact frequency with a group or groups of customers most likely to generate additional sales in response to an increased contact frequency.

10. A method of improving effectiveness of direct personal promotion efforts in a marketing environment in accordance with claim 9, wherein said step of adjusting the specified contact frequency comprises increasing a quantity of contacts made with a group of identified customers within said selected subset of customers in a specified time period.

11. A method of improving effectiveness of direct personal promotion efforts in a marketing environment in accordance with claim 9, wherein said step of adjusting the specified contact frequency comprises decreasing a quantity of contacts made with a group of identified customers within said selected subset of customers.

12. A method of improving effectiveness of direct personal promotion efforts in a marketing environment in accordance with claim 9, wherein said step of adjusting the specified contact frequency comprises increasing a quantity of contacts made with a first group of identified customers within said selected subset of customers and decreasing a quantity of contacts made with a second group of identified customers within said selected subset of customers.

13. A method of improving effectiveness of direct personal promotion efforts in a marketing environment in accordance with claim 9, further comprising:
measuring changes in actual contacts by said sales representatives with said selected subset of customers.

14. A method of improving effectiveness of direct personal promotion efforts in a marketing environment in accordance with claim 9, further comprising:
using a measured change in promotional response among said selected subset of customers as an input to creation of an updated prioritized suggested list with a modified contact frequency decreasing contact frequency with a category of customers whose promotional response is least affected by a decrease in contact frequency.

15. A software process for creating a prioritized suggested list for direct personal promotion efforts by contacts by sales representatives, comprising the steps of:
accessing a database of customers;
creating a prioritized suggested list of customers for sales representatives of an organization to use in contacting customers, said sales representatives having the ability to alter the specified contact frequency, said prioritized suggested list defining a call frequency for identified customers or groups of customers, said call frequency being determined by calculation of expected promotional response by said customer or groups of customers, with a high call frequency being assigned to customers having a historical pattern of desirable promotional response to direct promotion efforts;
incrementally altering the call frequency for a selected subset of customers to create an adjusted prioritized suggested list such that the sales representatives are unaware of the adjustment of specified contact frequency;
communicating said adjusted prioritized suggested list or portions thereof to said sales representatives;
measuring changes in the promotional response among said selected subset of customers;
using a measured change in promotional response among said selected subset of customers as an input to creation of an updated prioritized suggested list with a modified call frequency increasing call frequency to an identified class of customers most likely to yield additional sales.

16. A process for creating a prioritized suggested list for direct personal promotion efforts by contacts by sales representatives in accordance with claim 15, wherein said step of altering the call frequency comprises increasing a quantity of contacts made with a group of identified customers within said selected subset of customers.

17. A process for creating a prioritized suggested list for direct personal promotion efforts by contacts by sales representatives in accordance with claim 15, wherein said step of altering the call frequency comprises decreasing a quantity of contacts made with a group of identified customers within said selected subset of customers.

18. A process for creating a prioritized suggested list for direct personal promotion efforts by contacts by sales representatives in accordance with claim 15, wherein said step of altering the call frequency comprises increasing a quantity of contacts made with a first group of identified customers within said selected subset of customers and decreasing a quantity of contacts made with a second group of identified customers within said selected subset of customers.

19. A method of improving effectiveness of direct personal promotion efforts of pharmaceutical sales representatives contacting prescribing physicians in accordance with a prioritized suggested list, wherein said pharmaceutical sales representatives have the ability to alter the specified contact frequency; comprising the steps of:
creating on a computer an electronic prioritized suggested list of prescribing physicians for pharmaceutical sales representatives to use in contacting the prescribing physicians, said electronic prioritized suggested list including an identification of each prescribing physician and a specified contact frequency for each such prescribing physician to be executed by said pharmaceutical sales representatives;
adjusting the specified contact frequency for a selected subset of customers to create an electronic adjusted prioritized suggested list with an adjusted contact frequency, said adjustment of specified contact frequency for a selected subset of customers in said adjusted prioritized suggested list being incremental such that the sales representatives are unaware of the adjustment of specified contact frequency;
communicating said adjusted electronic prioritized suggested list or portions thereof to said pharmaceutical sales representatives;
measuring changes in the promotional response among said selected subset of prescribing physicians;
using a measured change in promotional response among said selected subset of prescribing physicians as an input to creation of an updated electronic prioritized suggested list with a modified contact frequency targeting prescribing physicians most likely to generate additional sales of pharmaceuticals;
communicating said updated electronic prioritized suggested list or portions thereof to said pharmaceutical sales representatives;

20. A method of improving effectiveness of direct personal promotion efforts in accordance with claim 19, wherein said step of adjusting the specified contact frequency comprises increasing a quantity of contacts made with said selected subset of prescribing physicians in a specific time period.

21. A method of improving effectiveness of direct personal promotion efforts in accordance with claim 19, wherein said step of adjusting the specified contact frequency comprises decreasing a quantity of contacts made with said selected subset of prescribing physicians in a specific time period.

22. A method of improving effectiveness of direct personal promotion efforts in accordance with claim 19, wherein said step of adjusting the specified contact frequency comprises increasing a quantity of contacts made with a first group of identified prescribing physicians contained within said selected subset of prescribing physicians and decreasing a quantity of contacts made with a second group of identified prescribing physicians contained within said selected subset of prescribing physicians.

23. A method of improving effectiveness of direct personal promotion efforts in accordance with claim 19, further comprising:
using a measured change in promotional response among said selected subset of prescribing physicians as an input to creation of an updated electronic prioritized suggested list with a modified contact frequency decreasing contact frequency with a category of prescribing physicians whose promotional response is least affected by a decrease in contact frequency.
